(19) United States
(12) Patent Application Publication
(10) Pub. No.: US 2009/0045941 A1
(43) Pub. Date: Feb. 19, 2009

(54) WIRELESS, REMOTE CONTROLLED, AND SYNCHRONIZED LIGHTING SYSTEM

(76) Inventor: John Cooper, Huntington Beach, CA (US)

Correspondence Address: Edward Y. Lin;SNELL & WILMER L.L.P., Suite 1400, 600 Anton Boulevard, Costa Mesa, CA, 92626, US

(21) Appl. No.: 12/190,154

(22) Filed: Aug. 12, 2008

Related U.S. Application Data
(60) Provisional application No. 60/955,707, filed on Aug. 14, 2007.

(51) Int. Cl. G08B 1/00; F21L 4/00

(52) U.S. Cl. 340/539.1; 362/157

(57) ABSTRACT

The invention relates to a lighting system and more specifically a wireless, remote controlled, and synchronized lighting system. In one embodiment, the present invention is a wireless lighting system including a first signal transmission unit, and a first wireless lighting module, wherein the first wireless lighting module illuminates according to a signal from the first signal transmission unit.

### RELATED APPLICATIONS

The present application claims the benefit of U.S. Provisional Patent Application No. 60/955,707 entitled WIRELESS, REMOTE CONTROLLED, AND SYNCHRONIZED LIGHTING SYSTEM filed on Aug. 14, 2007.

### BACKGROUND OF THE INVENTION

1. Field of the Invention

The invention relates to a lighting system and more specifically a wireless, remote controlled, and synchronized lighting system.

2. Description of the Related Art

Millions of families celebrate holidays by using illuminated decorations. For example, many homes decorate a Christmas tree with Christmas lights or include Christmas lights outside their homes. Families also put up large illuminated ornaments on the roof or on the lawn in the shape of characters such as Santa Clause, Frosty the Snowman, Rudolph the reindeer, etc. These large illuminated ornaments could also be mechanized, for example, to allow the Santa Clause to wave his arm.

However, the drawback with these illuminated decorations is that there is a plethora of cables. For example, the Christmas lights are all strung together on a cable. Also, the large illuminated ornament can have cables. This can be hazardous because cables can cause people to trip and/or fall. This is especially hazardous if the illuminated ornaments are placed outside in the winter with snow or other water elements and/or the cables become frayed and expose the copper connections. Furthermore, by leaving the cables connected to a power outlet, the illuminated decoration can continue to drain power from its electrical source and waste lots of energy. Furthermore, these illuminated decorations oftentimes illuminate or mechanically move independently of any other illuminated decorations.

Thus, there is a need for a lighting system which can reduce cable connections and synchronize the illuminated decorations.

### SUMMARY OF THE INVENTION

The present invention seeks to solve the problems describe above.

In one embodiment, the present invention is a wireless lighting system including a first signal transmission unit, and a first wireless lighting module, wherein the first wireless lighting module illuminates according to a signal from the first signal transmission unit.

In another embodiment, the present invention is a wireless lighting system including a first signal transmission unit, and a first wireless lighting module including a bulb, a microchip, and a cap, wherein the first wireless lighting module illuminates according to a signal from the first signal transmission unit.

In yet another embodiment, the present invention is a wireless lighting system including a first signal transmission unit, a first wireless lighting module including a first bulb, a first microchip, and a first cap, wherein the first wireless lighting module illuminates according to a signal from the first signal transmission unit, and a second wireless lighting module including a second bulb, a second microchip, and a second cap, wherein the second wireless lighting module illuminates according to a signal from the first signal transmission unit.

### BRIEF DESCRIPTION OF THE DRAWINGS

The exact nature of this invention as well as its objects and advantages will be readily understood upon consideration of the following specification as related to the attendant drawings wherein like reference numerals throughout the drawings indicate like parts, and wherein:

FIG. 1 is an exploded view of a wireless lighting module;

FIG. 2 depicts a lighting system including a wireless lighting module;

FIG. 3A is an embodiment of a lighting system;

FIG. 3B is an embodiment of a lighting system;

FIG. 3C is an embodiment of a lighting system;

FIG. 3D is an embodiment of a lighting system;

FIG. 4 depicts a lighting system including multiple wireless lighting modules;

FIG. 5 depicts a lighting system including multiple wireless lighting modules;

FIG. 6 depicts a lighting system including a wireless lighting module;

FIG. 7 is a perspective view of a storage unit for a wireless lighting system;

FIG. 8 is a perspective view of a storage unit for a wireless lighting system;

FIG. 9 is a perspective view of a storage unit for a wireless lighting system; and

FIG. 10 is a perspective view of a storage unit for a wireless lighting system.

### DESCRIPTION OF THE PREFERRED EMBODIMENTS

Methods and systems that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “one embodiment” or “an embodiment” in various places in the specification are not necessarily all referring to the same embodiment. Throughout the drawings, reference numbers are re-used to indicate correspondence between referenced elements.

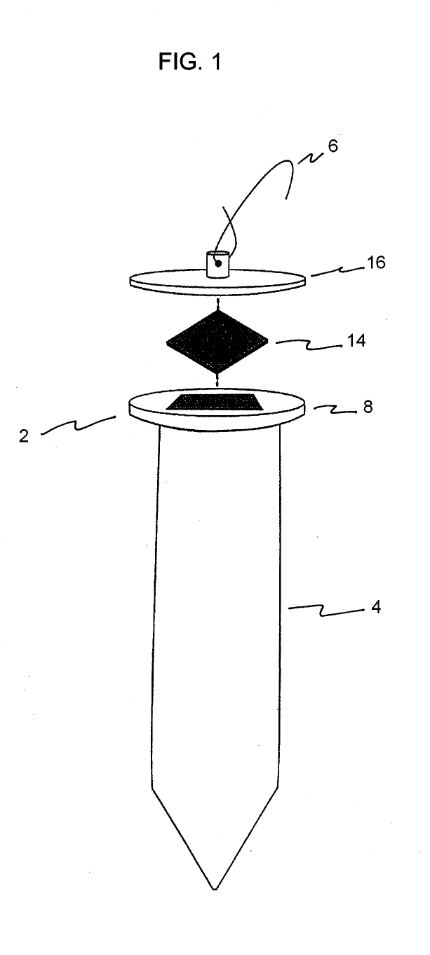

FIG. 1 is an exploded view of a wireless lighting module. Wireless lighting module 2 is a light emitting diode (LED) and can have a bulb 4, a battery 8, a microchip 14, a cap 16, and a hanging device 6 attached to the cap 16. Bulb 4 can house battery 8 and microchip 14 and can be sealed by cap 16. Hanging device 6 can, for example, be a wire, hook, or other device for securing wireless lighting module 2 to an object. Hanging device 6 is optional and can be substituted with fasteners, securing mechanisms, or omitted altogether. Wireless lighting module 2 can also be a variety of lighting emitting devices aside from an LED and can be in various shapes and sizes. Microchip 14 can be, for example, a microprocessor.

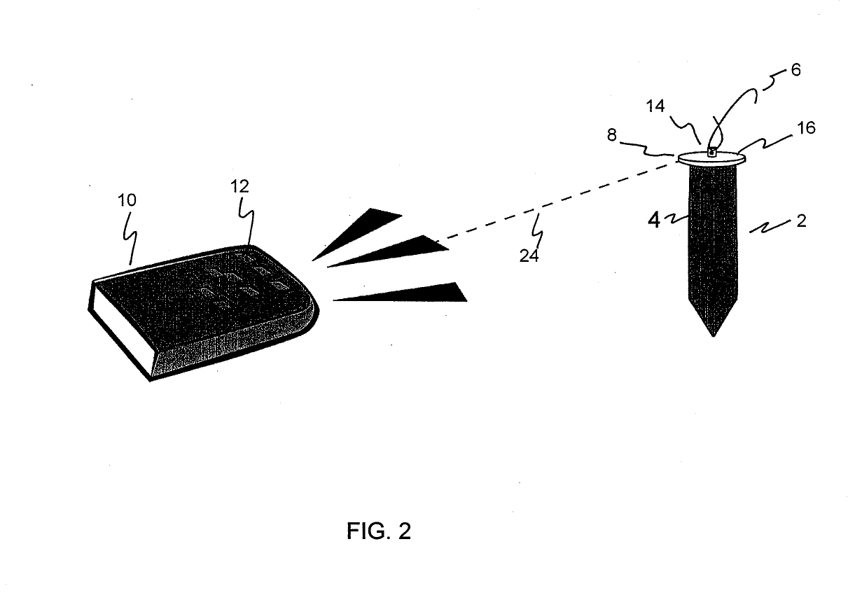

FIG. 2 depicts a lighting system including a wireless lighting module. The lighting system includes the wireless lighting module 2 and a remote control 10. Remote control 10 can have a plurality of buttons 12 and can be used to control the wireless lighting module 2. Remote control 10 can send a signal 24 to wireless lighting module 2 indicating that bulb 4 should illuminate and stay illuminated, or should illuminate in a certain pattern such as to flash repeatedly according to a predetermined pattern. Remote control 10 can also send a signal 24 to wireless lighting module 2 indicating that bulb 4 should cease illuminating and/or turn off completely to conserve energy. Microchip 14 can receive the signal by itself or through some other signal reception module such as an RF module (not shown) and interpret the signal 24 to determine bulb 4 should do. Furthermore, battery 8 can supply electrical power for so that microchip 8 may operate and bulb 4 may illuminate. Signal 24 can be a radio wave, a light wave, a sound wave, a Bluetooth signal, Wi-Fi signal, or other types of signals.

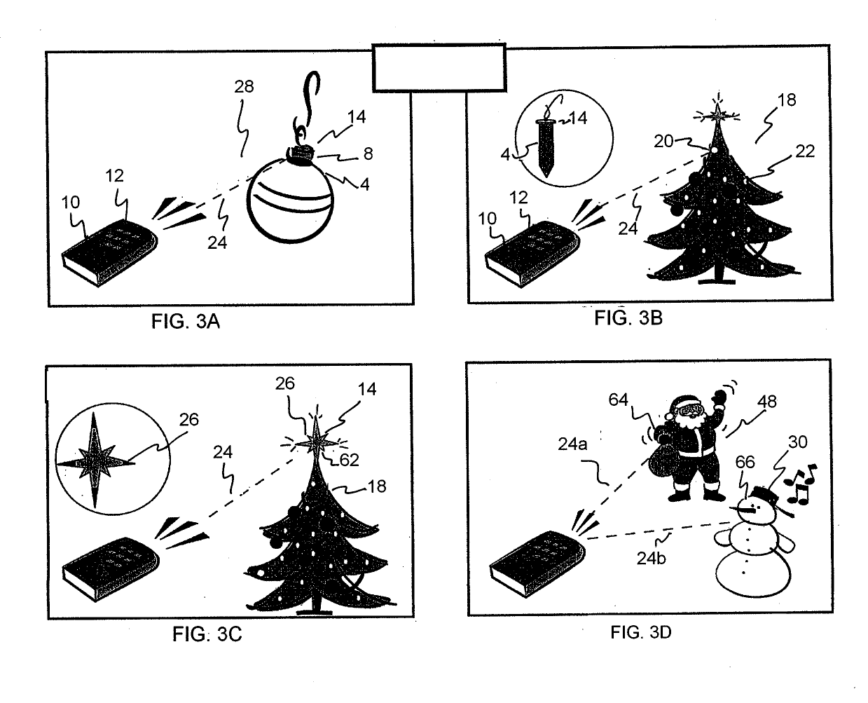

FIGS. 3A to 3D depict various embodiments of a lighting system. FIG. 3A depicts a wireless lighting module 28 which is an alternative embodiment to wireless lighting module 2. Wireless lighting module 28 is an ornament that can be illuminated. Thus, remote control 10 with a plurality of buttons 12 can send a signal 24 to control wireless lighting module 28. Microchip 14 can then determine based on the signal 24 by itself or through some other signal reception module such as an RF module (not shown) whether bulb 4 should illuminate, what pattern to illuminate, or cease illuminating.

FIG. 3B depicts a master wireless lighting module 20 and a slave wireless lighting module 22 which are alternative embodiments to wireless lighting module 2. Remote control 10 with a plurality of buttons 12 can send a signal 24 to control master wireless lighting module 28. Microchip 14 in the master wireless lighting module 20 can then determine based on the signal 24 by itself or through some other signal reception module such as an RF module (not shown) whether bulb 4 should illuminate, what pattern to illuminate, or cease illuminating. Master wireless lighting module 20 and slave wireless lighting module 22 can be hung on support structure 18, which in this case is a tree. Support structure 18 can also be a Christmas tree, a wall, a box, a table, a house, etc.

Furthermore, master wireless lighting module 20 can use a signal transmission module (not shown) to transmit a signal to a plurality of slave wireless lighting modules 22. Microchip 14 in the slave wireless lighting module 22 can then determine based on the signal from master wireless lighting module 20 by itself or through some other signal reception module such as an RF module (not shown) whether bulb 4 should illuminate, what pattern to illuminate, or cease illuminating.

FIG. 3C depicts a wireless lighting module 26 which is an alternative embodiment to wireless lighting module 2. Wireless lighting module 26 is an ornament that can be illuminated by a bulb (not shown) inside the shell 62. Shell 62 is in a shape of a star, but can be a variety of other shapes such as an angel, a snowman, etc. Thus, remote control 10 with a plurality of buttons 12 can send a signal 24 to control wireless lighting module 26. Microchip 14 can then determine based on the signal 24 by itself or through some other signal reception module such as an RF module (not shown) whether bulb 4 should illuminate, what pattern to illuminate, or cease illuminating. Microchip 14 can be a microprocessor. Wireless lighting module 26 can be hung on support structure 18, which in this case is a tree. Support structure 18 can also be a Christmas tree, a wall, a box, a table, a house, etc.

FIG. 3D depicts wireless lighting modules 48 and 30 which are alternative embodiments to wireless lighting module 2. Wireless lighting modules 48 and 30 are large ornament that can be illuminated by a bulb (not shown) inside their shells 64 and 66 respectively. Both wireless lighting modules 48 and 30 can also be mechanized so that they can move their respective shells 64 and 66. For example, shell 64 can wave its arm while shell 66 can rotate its body. Shells 64 and 66 can also perform a variety of other movements. Remote control 10 with a plurality of buttons 12 can send signals 24a and 24b to control wireless lighting modules 48 and 30. A microchip (not shown) in each of the wireless lighting modules 48 and 30 can then determine based on the signals 24a and 24b by itself or through some other signal reception module such as an RF module (not shown) whether a bulb (not shown) should illuminate, what pattern to illuminate, or cease illuminating. Furthermore, the microchip can also synchronize or coordinate the movements of shells 64 and 66 to some sort of music, illumination pattern, etc. Also, the movements of shells 64 and 66 can be synchronized or coordinated with each other, or they could also move entirely in different patterns at different times.

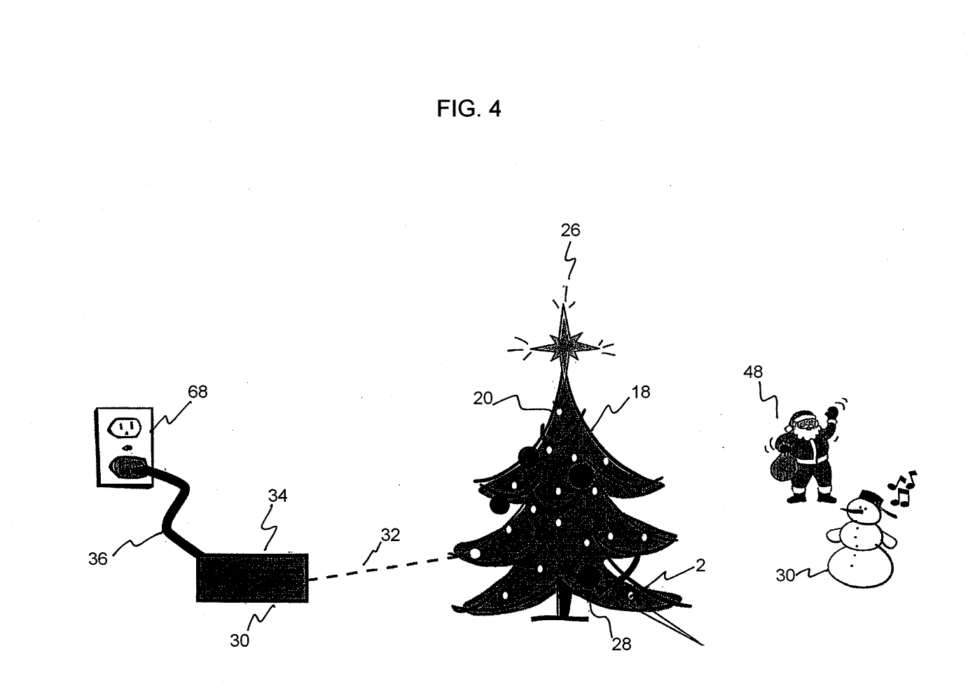

FIG. 4 depicts a lighting system including multiple wireless lighting modules. As can be seen, a signal transmission device 30 can replace a remote control 10. The signal transmission device 30 is a router, but can be other electronic devices such as a blackberry, an iPod, an iPhone, a cell phone, etc. Signal transmission device 30 can have a microchip 34, which in this case can be a microprocessor. It can also have an optional cable 36 to connect it to an electrical source 68 which can supply power to the signal transmission device 30. Signal transmission device can transmit a signal 32 to wireless lighting modules 2, 26, and 28 on support structure 18. It can also transmit signals to wireless lighting module 30 and 38. Thus, signal transmission device 30 can control the illumination and/or mechanical movement of wireless lighting modules 2, 26, 28, 30, and 38. It is also contemplated that signal transmission device 30 could also send signals to a master wireless lighting module 20. Master wireless lighting module 20 could then send signals to wireless lighting modules 2, 26, 28, 30, and 38 to control their illumination and/or mechanical movement.

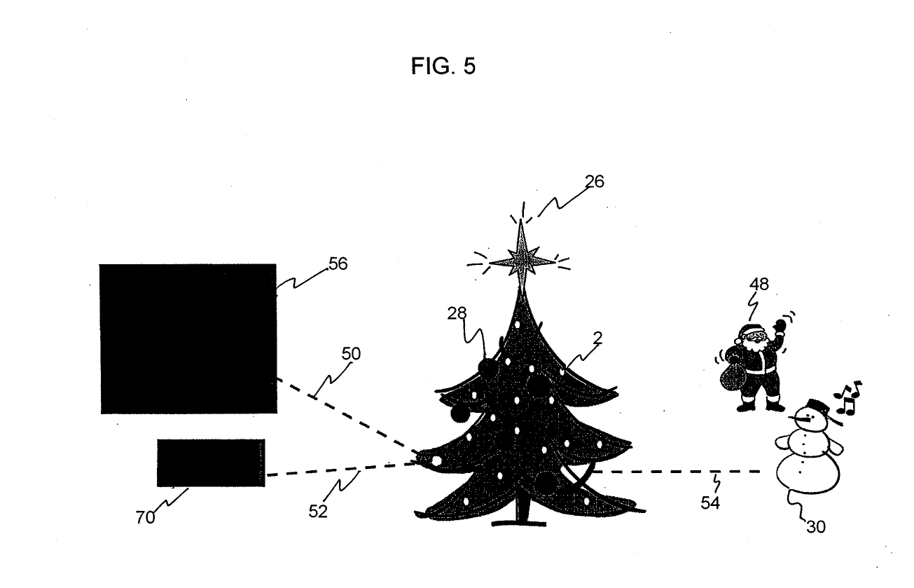

FIG. 5 depicts a lighting system including multiple wireless lighting modules. In FIG. 5, there are also multiple signal transmission devices including signal transmission devices 56 and 70. Signal transmission device 70 can be a cable box and can send signal 52 to one or more of the wireless lighting modules 2, 26, 28, 30, and 48. Signal transmission device 56 can be a television and can send signal 56 to one or more of the wireless lighting modules 2, 26, 28, 30, and 48. Signal 50 can be, for example, visual images, sounds, radio waves, electromagnetic waves, etc. Furthermore, one or more of the wireless lighting modules 2, 26, and 28 can send a signal 54 to wireless lighting modules 30 and/or 48.

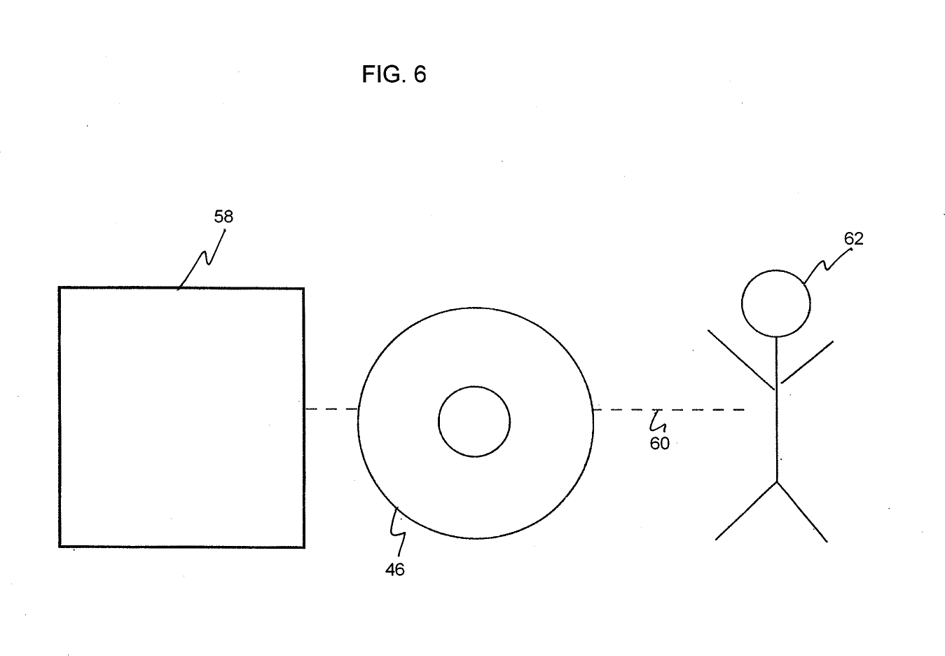

FIG. 6 depicts a lighting system including a wireless lighting module. As can be seen in FIG. 6, signal transmission device 58 is a compact disc (CD) player which can receive a CD 46 and send a signal 60 based wholly or in part on the content of CD 46 to control the illumination and/or movement of a wireless lighting module 62. Thus, wireless lighting module 62 can illuminate and/or perform mechanical movements based on the sounds from CD 46.

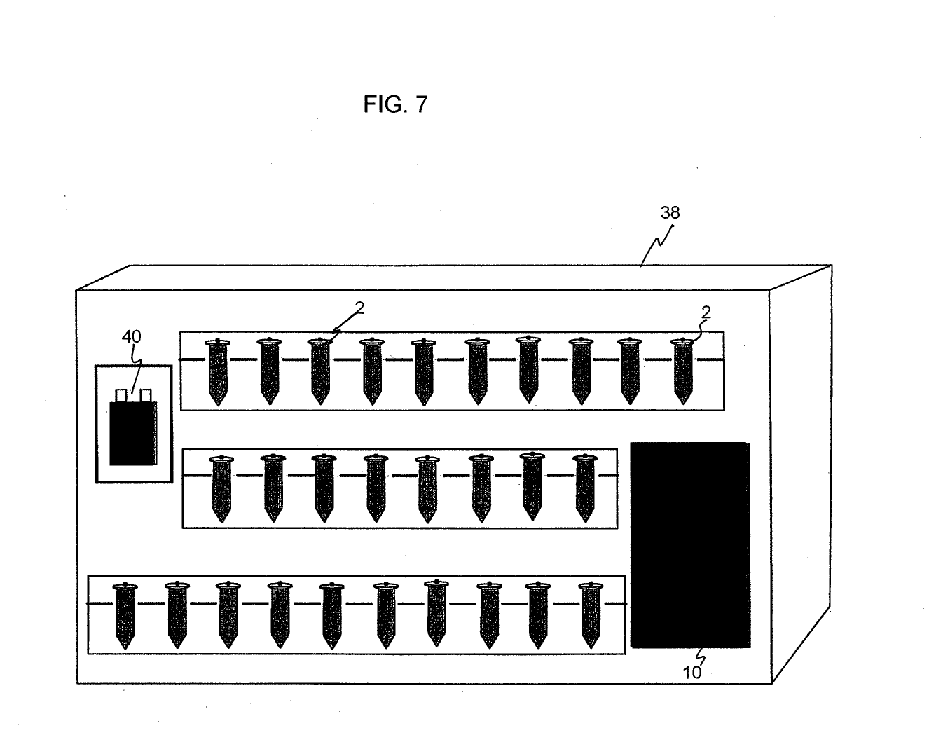

FIG. 7 is a perspective view of a storage unit for a wireless lighting system. A plurality of wireless lighting modules 2, remote control 10, and battery 40 can be stored in a storage unit 38. Storage unit 38 could allow the plurality of wireless lighting modules 2 and/or remote control 10 to be electrically connected to a battery 40. Battery 40 can then recharge the plurality of wireless lighting modules 2 and/or remote control 10. Battery 40 can be a 9V battery, a AA battery, a AAA battery, a C battery, a D battery, etc. Furthermore it is contemplated that more than one battery 40 can be stored in storage unit 38.

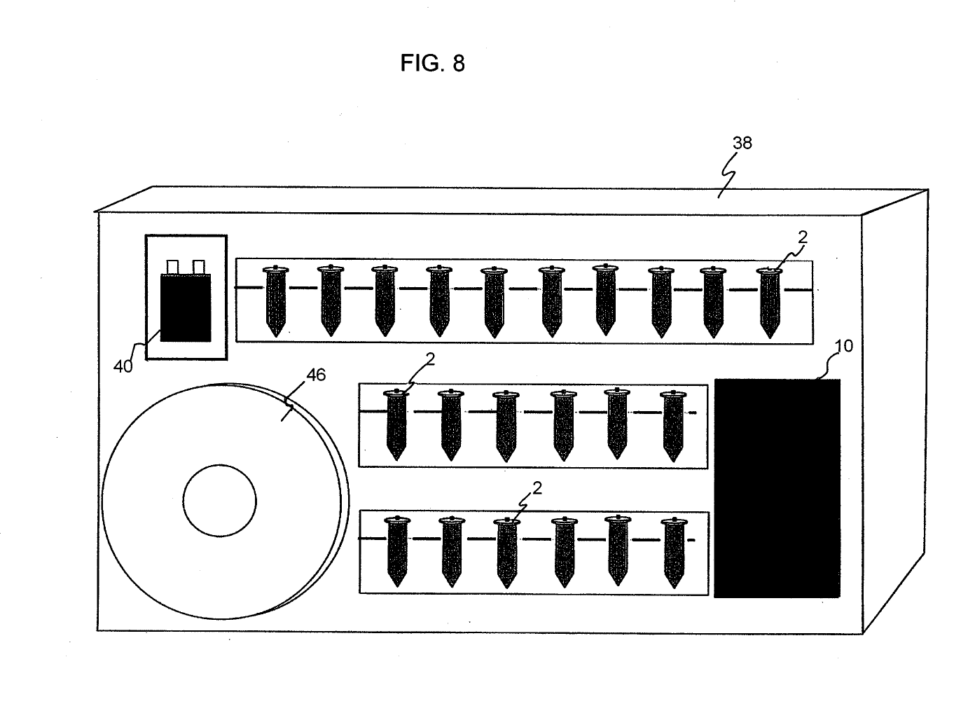

FIG. 8 is a perspective view of a storage unit for a wireless lighting system. In this embodiment, storage unit 38 could also store CD and/or DVD 46.

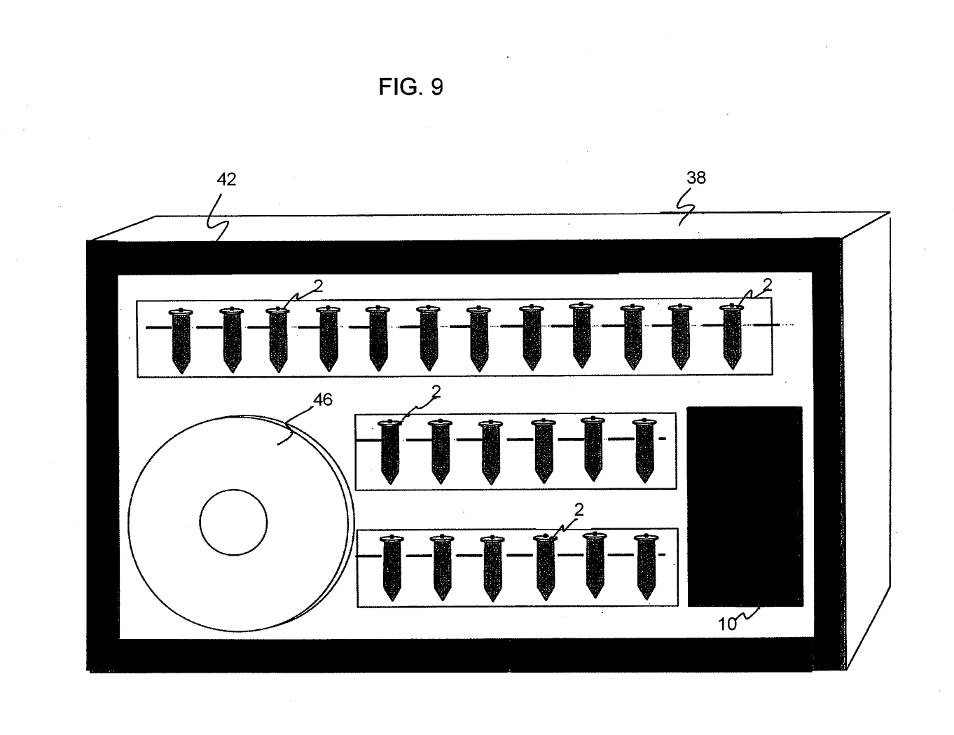

FIG. 9 is a perspective view of a storage unit for a wireless lighting system. In this embodiment, storage unit 38 includes a solar panel 42. Storage unit 38 an also have a removable or semi-permanent battery (not shown) inside storage unit 38 to store and transmit the power obtained from solar panel 42. Solar panel 42 can be electrically connected to the plurality of wireless lighting modules 2 and/or remote control 10 and power from solar panel 42 can be used to recharge the plurality of wireless lighting modules 2 and/or remote control 10.

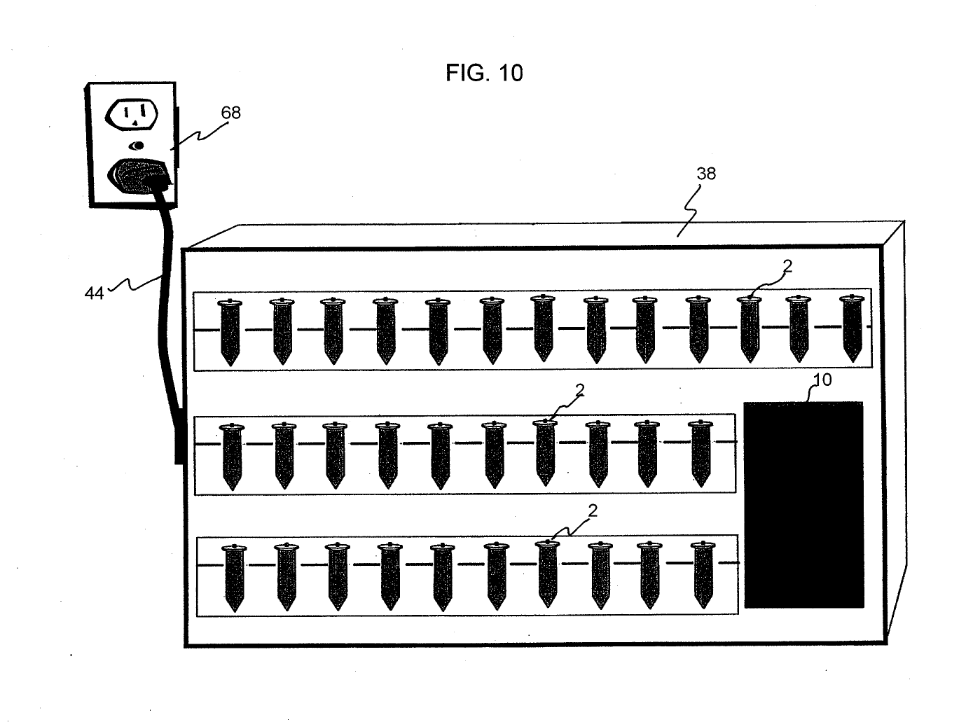

FIG. 10 is a perspective view of a storage unit for a wireless lighting system. In this embodiment, storage unit 38 includes a cable 44 to connect storage unit 38 to an electric source 68. Storage unit 38 an also have a removable or semi-permanent battery (not shown) inside storage unit 38 to store and transmit the power obtained from electric source 68 via cable 44. Electric source 68 can be electrically connected to the plurality of wireless lighting modules 2 and/or remote control and power from electric source 68 can be used to recharge the plurality of wireless lighting modules 2 and/or remote control.

While not shown, it is also contemplated that one or more of the wireless lighting modules could have energy replenishment module such as a solar panel, solar ribbon, and/or photovoltaic cell. The energy replenishment module, could for example, aid in recharging the battery of the wireless lighting modules. This could reduce the need for the wireless lighting modules to be recharged and/or connected to storage unit 38. This could also extend the life of the battery.

The energy replenishment module could be placed, for example on top of the cap of the wireless lighting module or on a circumference of the cap. It could also be placed in other locations that would aid in converting light into energy to recharge the battery. Furthermore, the energy replenishment module could have a variety of sizes. For example, it could encompass a portion of the cap in lighting module 2 or it could encompass a significant portion of a backside of lighting modules 30 and/or 48 in FIG. 3D.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described preferred embodiment can be configured without departing from the scope and spirit of the invention. Therefore, it is to be understood that, within the scope of the appended claims, the invention may be practiced other than as specifically described herein.

What is claimed is:

1. A wireless lighting system comprising:
a first signal transmission unit; and
a first wireless lighting module, wherein the first wireless lighting module illuminates according to a signal from the first signal transmission unit.

2. The wireless lighting system of claim 1 wherein the wireless lighting module further includes a bulb.

3. The wireless lighting system of claim 2 wherein the wireless lighting module further includes a microchip.

4. The wireless lighting system of claim 3 wherein the wireless lighting module further includes a cap.

5. The wireless lighting system of claim 4 wherein the first signal transmission unit is a remote control.

6. The wireless lighting system of claim 4 wherein the first signal transmission unit is a router.

7. The wireless lighting system of claim 4 further comprising a second wireless lighting module.

8. The wireless lighting system of claim 7 wherein the second wireless lighting module illuminates according to a signal from the first signal transmission unit.

9. The wireless lighting system of claim 7 wherein the first wireless lighting module and the second wireless lighting module illuminate according to a coordinated pattern from the signal from the first signal transmission unit.

10. The wireless lighting system of claim 9 further comprising a second signal transmission unit.

11. The wireless lighting system of claim 10 the signal from the first signal transmission unit is a sound wave, a light wave, a radio wave, a Bluetooth signal, or a Wi-Fi signal.

12. A wireless lighting system comprising:
a first signal transmission unit; and
a first wireless lighting module including
a bulb,
a microchip, and
a cap,
wherein the first wireless lighting module illuminates according to a signal from the first signal transmission unit.

13. The wireless lighting system of claim 12 wherein the first signal transmission unit is a remote control, router, television, or cable box.

14. The wireless lighting system of claim 13 further comprising a second wireless lighting module.

15. The wireless lighting system of claim 14 wherein the second wireless lighting module illuminates according to a signal from the first signal transmission unit.

16. The wireless lighting system of claim 14 wherein the first wireless lighting module and the second wireless lighting module illuminate according to a coordinated pattern from the signal from the first signal transmission unit.

17. The wireless lighting system of claim 16 further comprising a second signal transmission unit.

18. The wireless lighting system of claim 17 the signal from the first signal transmission unit is a sound wave, a light wave, a radio wave, a Bluetooth signal, or a Wi-Fi signal.

19. A wireless lighting system comprising:
a first signal transmission unit;
a first wireless lighting module including
a first bulb,
a first microchip, and
a first cap,
wherein the first wireless lighting module illuminates according to a signal from the first signal transmission unit; and
a second wireless lighting module including
a second bulb,
a second microchip, and
a second cap,
wherein the second wireless lighting module illuminates according to a signal from the first signal transmission unit.

20. The wireless lighting system of claim 19 further comprising a second signal transmission unit.
